(19) United States
(12) Patent Application Publication
(10) Pub. No.: US 2018/0241497 A1
(43) Pub. Date: Aug. 23, 2018

(54) PLANAR ELECTROMAGNETIC WAVE GENERATION APPARATUS FOR CONCENTRATING ORBITAL ANGULAR MOMENTUM AND METHOD THEREFOR

(71) Applicant: Electronics and Telecommunications Research Institute, Daejeon (KR)

(72) Inventors: Ju Yeon HONG, Daejeon (KR); Myung Sun SONG, Daejeon (KR); Wang Joo LEE, Daejeon (KR)

(73) Assignee: Electronics and Telecommunications Research Instit ute, Daejeon (KR)

(21) Appl. No.: 15/902,718

(22) Filed: Feb. 22, 2018

(30) Foreign Application Priority Data
Feb. 22, 2017 (KR) 10-2017-0023517
May 31, 2017 (KR) 10-2017-0067658

(51) Int. Cl. H04J 14/04; H04B 10/2581; H04B 10/50

(52) U.S. Cl. CPC H04J 14/04; H04B 10/70; H04B 10/50; H04B 10/2581

(57) ABSTRACT

Provided are a technique for providing focused Bessel beams having orbital angular momentum (OAM) to a plane to solve a problem of the related art in which Laguerre-Gaussian (LG) beams having OAM and used for multiplexing of a microwave transmission system are dispersed, and an electromagnetic wave generation apparatus and method for implementing the technique.

### CLAIM FOR PRIORITY

This application claims priorities to Korean Patent Applications No. 2017-0023517 filed on Feb. 22, 2017 and No. 2017-0067658 filed on May 31, 2017 in the Korean Intellectual Property Office (KIPO), the entire contents of which are hereby incorporated by reference.

### BACKGROUND

### 1. Technical Field

Example embodiments of the present invention relate in general to a technique for providing focused Bessel beams having orbital angular momentum (OAM) to a plane in an existing technical field in which light waves and electromagnetic waves are generated and used, and more specifically to an electromagnetic wave generation apparatus and method for implementing the technique.

### 2. Related Art

Most frequency bands that are currently used in wireless communication are densely divided and used without an idle band. Due to the expanding trend of multimedia data service, it is necessary to improve the efficiency of an existing frequency band. To this end, it is possible to use electromagnetic wave polarization or multi-antenna characteristics. Since there is a limitation in improving transmission efficiency even when several multiplexing techniques are used, a new communication method in which an OAM mode is used is being researched in the optical communication field and the like. In particular, according to OAM mode multiplexing, even when frequency, polarization, and multi-antenna arrangement characteristics and the like are the same, it is possible to distinguish a communication signal carried by each mode using mathematical orthogonality between OAM modes. Also, as known as Emmy Noether's theorem, OAM (L) is conserved in a system that is symmetrical with respect to an axis of rotation. Due to the characteristic of conservation, OAM may be used to improve efficiency of radio wave spectrum that may be transmitted in free-space optical communication (FSO) and microwave communication.

According to related art, an OAM mode is a Laguerre-Gaussian (LG) mode that is a solution of the paraxial Helmholtz equation, and has a main beam in a donut shape around a propagation axis of electromagnetic waves when the electromagnetic waves are transmitted. Therefore, the LG mode has problems in that a beam size increases along with a propagation distance and it is difficult to increase a transmission distance. In addition, there is a limitation in that a receiving antenna is required to be large and complicated.

### SUMMARY

Accordingly, example embodiments of the present invention are provided to substantially obviate one or more problems due to limitations and disadvantages of the related art.

Example embodiments of the present invention reduce the size of beams having orbital angular momentum (OAM), and detailed means for the purpose are as follows.

The present invention has two elements.

First, a phased-array structure that generates an equiphase surface in a conical shape inclined toward an axis generates Bessel beams.

Second, a helical phased-array structure having a phase difference of 2πL (L=−1, . . . −1, 0, 1, . . . , and +1) in the direction of an azimuth Φ with respect to an axis has OAM.

Consequently, example embodiments of the present invention combine the two elements so that the two elements are simultaneously satisfied, and provide an electromagnetic wave generation apparatus for generating focused Bessel beams having OAM by adjusting an equiphase surface in which the two elements are combined by a circular-array antenna on one plane, and a method of generating focused Bessel beams having OAM.

### BRIEF DESCRIPTION OF DRAWINGS

Example embodiments of the present invention will become more apparent by describing in detail example embodiments of the present invention with reference to the accompanying drawings, in which:

FIG. 1 shows an example of a planar circular-array apparatus for generating an electromagnetic wave that has an equiphase surface simultaneously having a helicoidal shape in an azimuthal direction and a conical shape inclined toward an axis according to an example embodiment of the present invention, and a generated equiphase wavefront.

FIG. 2 is a diagram showing a spiral phase plate (SPP) for generating Laguerre-Gaussian (LG) mode beams having a helicoidal equiphase surface.

FIG. 3 is a diagram showing an axicon that focuses Gaussian modes as Bessel mode beams having a conical equiphase surface.

FIG. 4 shows generation of helical beams focused through an SPP and an axicon using an electromagnetic wave generation apparatus.

FIG. 5 is a diagram showing a circular-array apparatus for generating an electromagnetic wave according to an exemplary embodiment of the present invention in which a k^{th} unit structure from the center of the circle has a k·d sin θ phase-shifted structure so that the phase of light simultaneously has a helicoidal shape having the term “exp(±ilϕ)” in an azimuthal direction and an equiphase surface in a conical shape inclined toward an axis.

FIG. 6 is a block diagram showing a configuration of an orbital angular momentum (OAM)-mode antenna apparatus according to an example embodiment of the present invention.

FIGS. 7A to 7D are diagrams showing examples of a signal output by an OAM-mode antenna apparatus according to an example embodiment of the present invention.

FIG. 8 is a diagram showing an example of a tractroid shape used by an OAM-mode antenna apparatus according to an example embodiment of the present invention.

FIGS. 9A to 9C are first example diagrams of an antenna structure provided in an OAM-mode antenna apparatus according to an example embodiment of the present invention.

FIGS. 10A and 10B are second example diagrams of an antenna structure provided in an OAM-mode antenna apparatus according to an example embodiment of the present invention.

FIG. 11 is a third example diagram of an antenna structure provided in an OAM-mode antenna apparatus according to an example embodiment of the present invention.

FIG. 12 is a fourth example diagram of an antenna structure provided in an OAM-mode antenna apparatus according to an example embodiment of the present invention.

FIG. 13 is a fifth example diagram of an antenna structure provided in an OAM-mode antenna apparatus according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, and example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, an apparatus and method for generating an electromagnetic wave according to exemplary embodiments of the present invention will be described with reference to drawings.

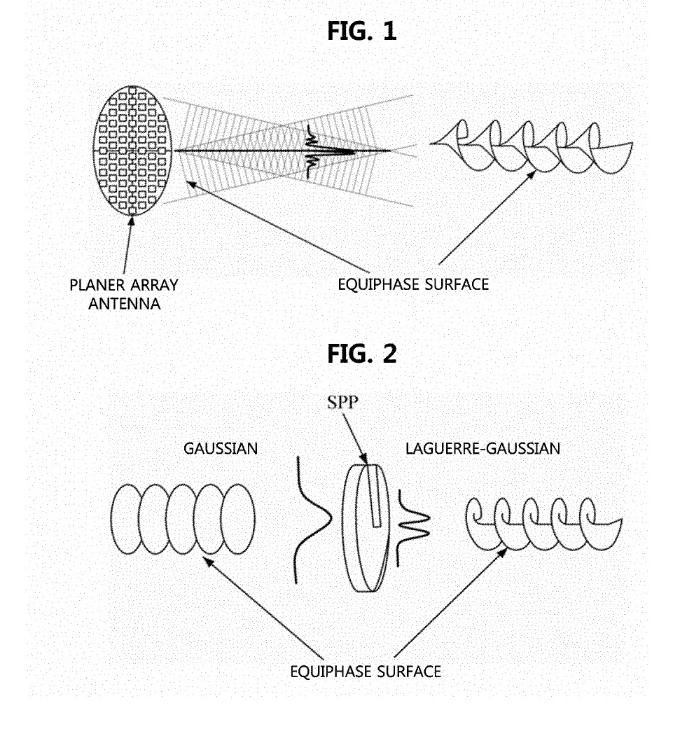

A representative drawing of the present invention is FIG. 1, which shows a planar circular-array apparatus for generating an electromagnetic wave of a phase structure that is identical to a higher-order Bessel mode and has a conical and helicoidal equiphase surface. In the present invention, the phase of light simultaneously has a helicoidal shape, which has the term “exp(±ilϕ)”, in an azimuthal direction and an equiphase surface in a conical shape inclined toward an axis. However, the present invention is not limited to the phase of light and includes a form of focusing a mode in which orthogonality of orbital angular momentum (OAM) is used.

According to an exemplary embodiment of the present invention, the distribution of complex-number amplitudes of a Laguerre-Gaussian (LG) mode having OAM is represented by Equation 1 below.

$${u}_{p , l} ( ρ , φ , z ) = {A}_{p , l} \frac{1}{w ( z )} [ \frac{ρ \sqrt{2}}{w ( z )} ] {}_{ }^{\vert l \vert}{L}{}_{p}^{\vert l \vert} [ - \frac{2 {ρ}^{2}}{{w}^{2} ( z )} ] exp [ - \frac{{ρ}^{2}}{{w}^{2} ( z )} ] \times exp ( \pm il φ ) exp [ - ik \frac{{ρ}^{2} z}{2 R ( z )} + i ( 2 p + \vert l \vert + 1 ) ξ ( z ) ] \qquad [ Equation 1 ]$$

Here, Lₚ^{l} denotes a Laguerre polynomial, ρ³=x²+y², ξ(z) denotes a Gouy phase, R(z) denotes a beam curvature, and w(z) denotes a beam radius, which is represented by Equation 2 below.

$$w ( z ) = {w}_{0} \sqrt{1 + {( \frac{z}{{z}_{R}} )}^{2}} \\ R ( z ) = z ( 1 + {( \frac{{z}_{R}}{z} )}^{2} ) \\ ξ ( z ) = {tan}^{- 1} \frac{z}{{z}_{R}} \\ {w}_{0} = \sqrt{\frac{λ {z}_{R}}{π}} \qquad [ Equation 2 ]$$

FIG. 2 is a diagram showing a spiral phase plate (SPP) for generating helical beams of an LG mode.

With regard to this, helical beams of an LG mode being generated by the SPP according to an exemplary embodiment of the present invention are shown.

According to an exemplary embodiment of the present invention, the distribution of complex-number amplitudes of a higher-order Bessel mode having OAM is represented by Equation 3 below.

$$u ( ρ , φ , z ) = A \frac{{w}_{0}}{w ( z )} exp [ - i ( k - \frac{{k}_{ρ}^{2} z}{2 k} ) z - ξ ( z ) ] {J}_{l} ( \frac{{k}_{ρ} ρ}{iz \text{/} {z}_{ρ}} ) \times exp ( \pm il φ ) exp [ ( \frac{- 1}{{w}^{2} ( z )} + \frac{ik}{2 R ( z )} ) ( {r}^{2} + \frac{{k}_{ρ}^{2} {z}^{2}}{{k}^{2}} ) ] \qquad [ Equation 3 ]$$

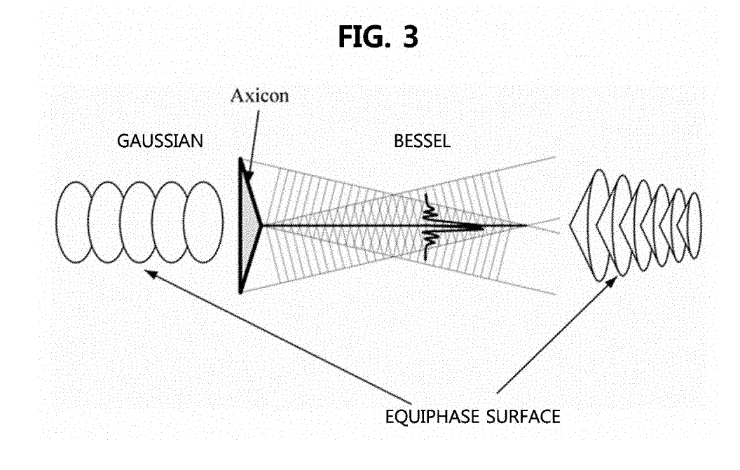

FIG. 3 is a diagram showing an axicon that focuses Gaussian modes as Bessel mode beams.

Referring to FIG. 3, Gaussian modes being focused as Bessel mode beams by the axicon according to an exemplary embodiment of the present invention are shown.

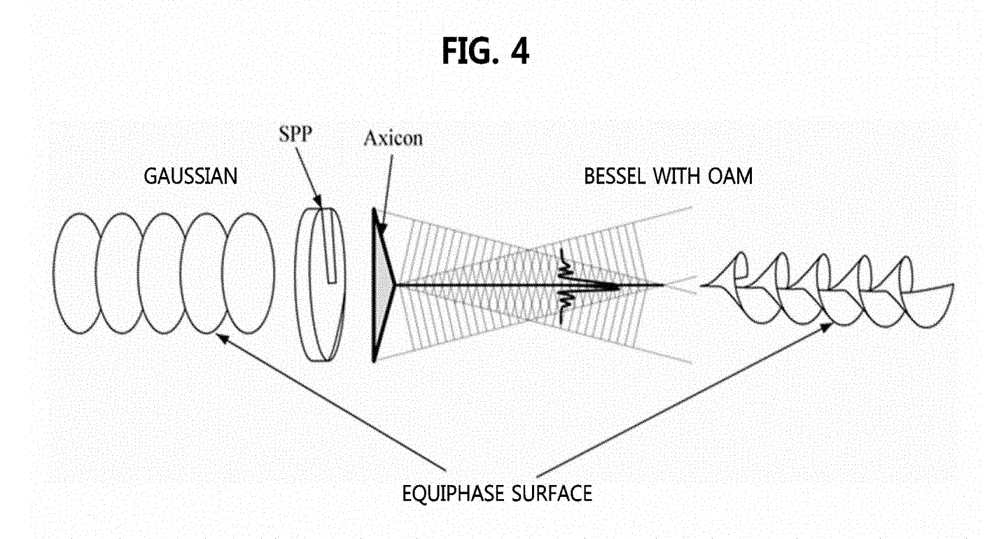

FIG. 4 shows an example of generating focused higher-order Bessel modes having OAM from incoming beams of Gaussian modes of related art through an SPP and an axicon. The present invention may provide one electromagnetic wave generation apparatus in which two effects of a helicoidal equiphase surface of LG-mode beams generated by an SPP and a conical equiphase surface of Bessel mode beams generated by an axicon are combined.

In the present invention, a planar circular array instead of two voluminous lens systems is used to generate helicoidal and conical electromagnetic waves such that focused electromagnetic waves having OAM may be generated.

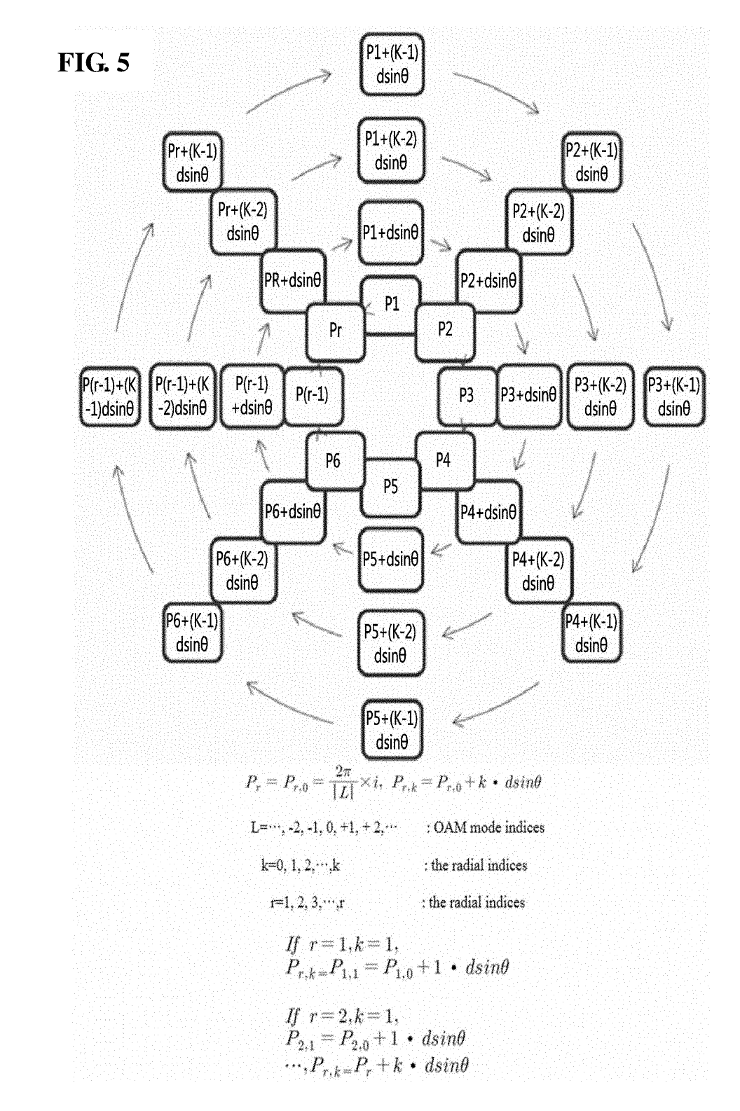

FIG. 5 is a diagram showing a circular-array apparatus for generating an electromagnetic wave according to an exemplary embodiment of the present invention whose phase of light has the term “exp(±ilϕ)” in an azimuthal direction and in which a k^{th} unit structure from a center has a k·d sin θ phase-shifted structure.

Each symbol shown in FIG. 5 may have a meaning as shown in Equation 4 below.

$${P}_{r} = {P}_{r , 0} = \frac{2 π}{\vert L \vert} \times i , {P}_{r , k} = {P}_{r , 0} + k \cdot d sin θ \qquad [ Equation 4 ]$$

L=−m, . . . , −2, −1, 0, +1, +2, . . . , +m; OAM mode indices; indices of vortex modes having OAM
i=1, 2, 3, . . . , and i; indices of azimuthal directions (from a reference axis)
r=1, 2, 3, . . . , and r; indices of radial directions (from the origin of the circle)
k=1, 2, . . . , and k; indices of circumferential directions (from the center)

According to an exemplary embodiment of the present invention, the electromagnetic wave generation apparatus may concentrate electromagnetic wave energy by generating electromagnetic waves having a helicoidal and conical equiphase surface.

According to an exemplary embodiment of the present invention, the electromagnetic wave generation apparatus may generate an electromagnetic wave in a higher-order pseudo-Bessel pattern having OAM.

According to an exemplary embodiment of the present invention, it is possible to generate Bessel beams using a phased-array structure whose equiphase surface has a conical shape inclined toward an axis.

According to an exemplary embodiment of the present invention, it is possible to shift a phase by 2πL (L=−1, . . . , −1, 0, 1, . . . , and +1) in the direction of an azimuth Φ with respect to an axis so as to generate a helicoidal wavefront in which the phase of light has the term “exp(±ilϕ)” in the azimuthal direction.

According to an exemplary embodiment of the present invention, a k^{th} unit structure from a center may be phase-shifted by k·d sin θ so that a radial equiphase surface has a conical shape.

According to an exemplary embodiment of the present invention, it is possible to generate focused electromagnetic waves having OAM using a planar array.

According to an exemplary embodiment of the present invention, an electromagnetic wave generation apparatus for can generate focused electromagnetic waves having OAM using a planar circular array whose central portion is empty or which has an irregular arrangement in radial directions.

In consideration of the above description, a method of improving a distance over which a beam is transmitted by an OAM mode is proposed according to an example embodiment of the present invention. In particular, when an antenna apparatus is configured on the basis of an LG mode included in the OAM mode, a maximum distance Zmax may be limited. A method of improving a distance by overcoming limitations of the maximum distance Zmax is proposed according to an example embodiment of the present invention.

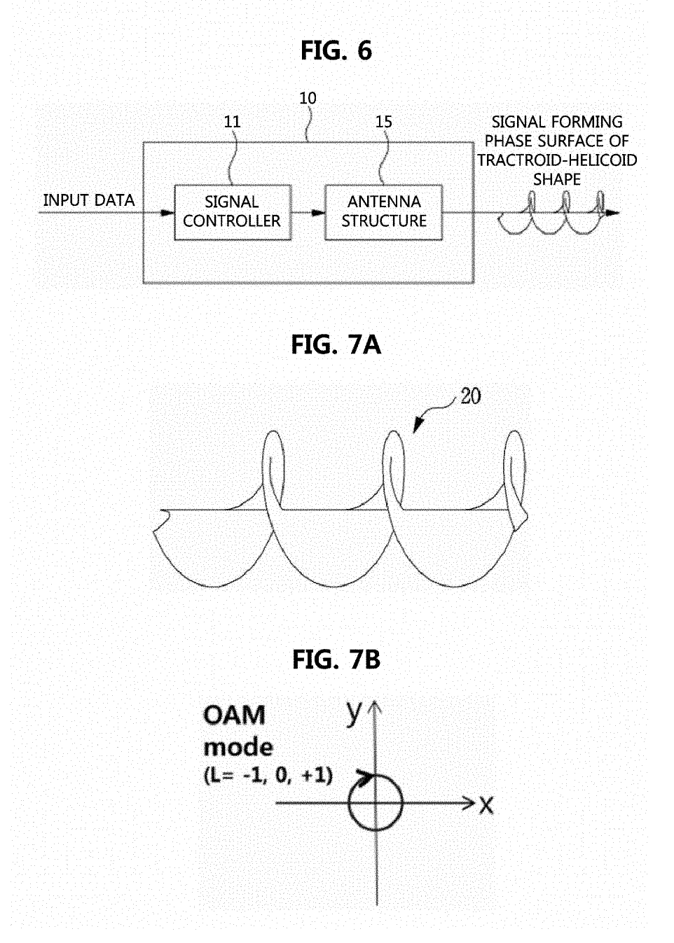

FIG. 6 is a block diagram showing a configuration of an OAM-mode antenna apparatus according to an example embodiment of the present invention. Referring to FIG. 6, an OAM-mode antenna apparatus 10 according to an example embodiment of the present invention may include a signal controller 11 and an antenna structure 15.

In consideration of a structure of the antenna structure 15, the signal controller 11 may control a signal so that a signal output through the antenna structure 15 forms a tractroid-helicoidal phase surface.

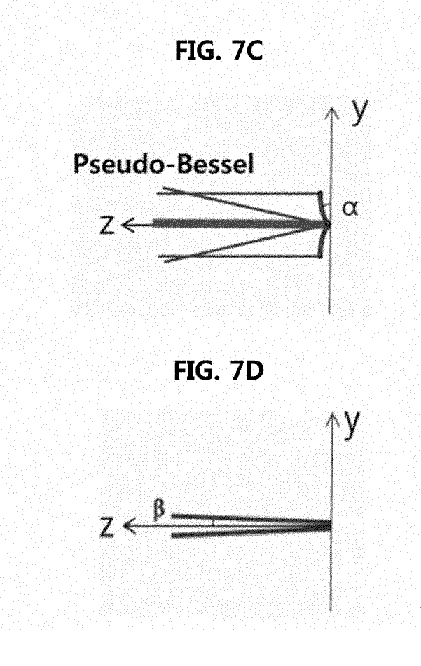

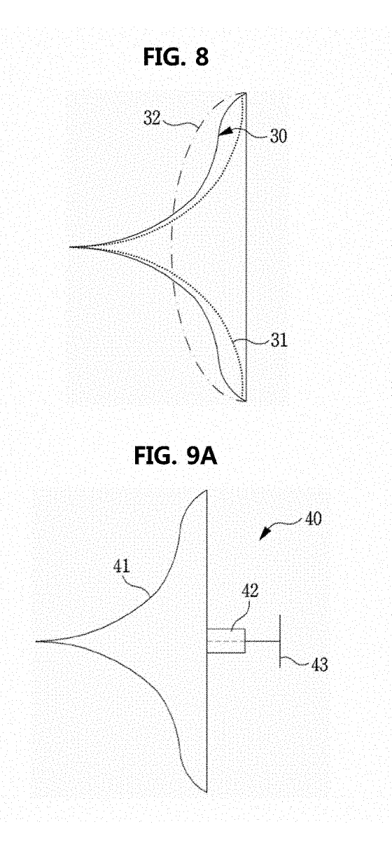

FIGS. 7A to 7D are diagrams showing examples of a signal output by an OAM-mode antenna apparatus according to an example embodiment of the present invention. In particular, FIG. 7A shows a tractroid-helicoidal wavefront, FIG. 7B shows a helicoidal element of FIG. 7A in an xy plane, FIG. 7C shows a tractroid element of FIG. 7A in a yz plane, and FIG. 7D shows pseudo-Bessel beams having the tractroid-helicoidal wavefront of FIG. 7A and travelling in a concentrated bundle. In this case, the beams may be minutely dispersed, and a transmission distance thereof may increase. FIG. 8 is a diagram showing an example of a tractroid shape used by an OAM-mode antenna apparatus according to an example embodiment of the present invention.

In an example embodiment of the present invention, a tractroid-helicoidal shape 20 may be formed by combining a helicoidal wavefront having a helicoidal phase surface and a tractroid-parabolic shape 30 having a phase surface forming a diverging Bessel mode, which is formed on the basis of a tractroid surface 31 and a parabolic surface 32 for correcting an error caused by using a single source.

Here, the tractroid-helicoidal shape 20 may be formed on the basis of OAM, and an OAM-based helical mode may be set in various ways. As an example, the OAM-based helical mode may be set to −m, . . . , −2, −1, 0, +1, +2, . . . , and +m (m is an integer).

As described above, a signal of the tractroid-helicoidal shape 20 output by an OAM-mode antenna apparatus according to an example embodiment of the present invention may ensure concentration of OAM mode beams and a transmission distance of the beams.

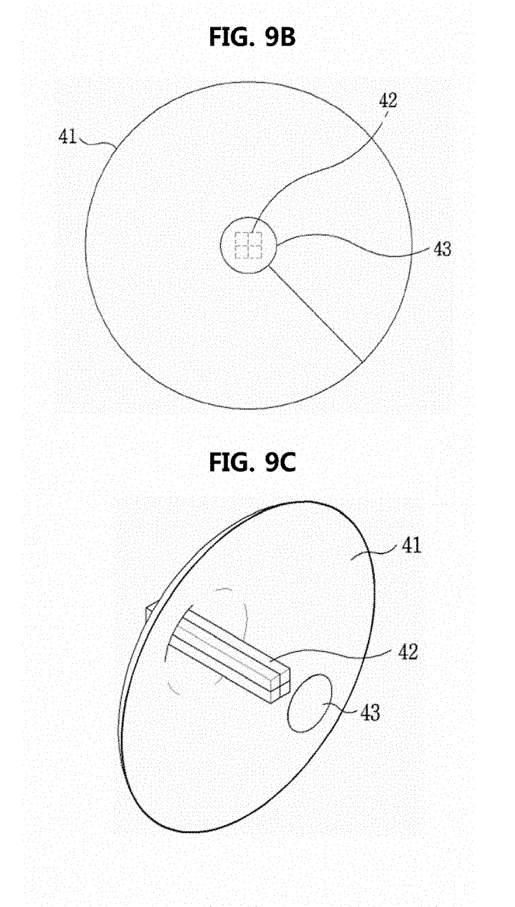

FIGS. 9A to 9C are first example diagrams of an antenna structure provided in an OAM-mode antenna apparatus according to an example embodiment of the present invention.

Referring to FIGS. 9A to 9C, an antenna structure according to a first example embodiment may have a tractroid-parabolic shaped reflecting plate 41, a 2×2 feeder 42, and an auxiliary reflecting plate 43.

The 2×2 feeder 42 and the auxiliary reflecting plate 43 may be arranged at opposite positions, and the auxiliary reflecting plate 43 may be provided at a position opposite to the reflecting plate 41. Due to this structure, a signal output from the 2×2 feeder 42 is reflected by the auxiliary reflecting plate 43 first and provided to the reflecting plate 41. The signal which is reflected by the auxiliary reflecting plate 43 first and incident on the reflecting plate 41, is reflected by the reflecting plate 41 second and output.

The signal output from the 2×2 feeder 42 may be controlled by the above-described signal controller 11. In consideration of the configuration of the antenna structure 41, 42, and 43 according to the first example embodiment, the signal controller 11 may control the signal so that a signal output by the antenna structure 41, 42, and 43 forms a tractroid-helicoidal phase surface. For example, the signal controller 11 may control a phase of the signal output from the 2×2 feeder 42 on the basis of OAM modulation. Here, the signal controller 11 may control a phase of the output signal by setting an OAM-based helical mode variously (−m, . . . , −2, −1, 0, +1, +2, . . . , and +m).

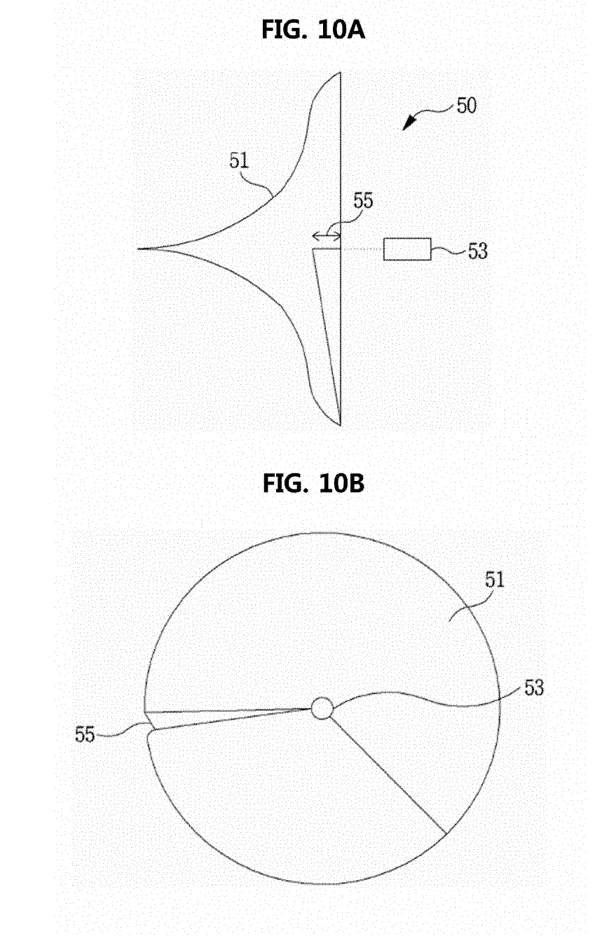

FIGS. 10A and 10B are second example diagrams of an antenna structure provided in an OAM-mode antenna apparatus according to an example embodiment of the present invention.

Referring to FIGS. 10A and 10B, an antenna structure 50 according to a second example embodiment may include a tractroid-parabolic-helicoidal reflecting plate 51 and a feeder horn 53.

The reflecting plate 51 may be formed in a tractroid-parabolic shape, and a reflecting surface thereof may have a helicoidal shape having a certain step 55. Here, the step 55 of the reflecting surface formed in the reflecting plate 51 may be set in consideration of a mode of a signal reflected by the reflecting plate 51, for example, an OAM-based helical mode (−m, . . . , −2, −1, 0, +1, +2, . . . , and +m).

The feeder horn 53 may be provided at a position opposite to the reflecting plate 51. Due to this structure, a signal output from the feeder horn 53 is provided to the reflecting plate 51, and the signal incident on the reflecting plate 51 is reflected by the reflecting plate 51 and output.

Since the reflecting plate 51 is formed in a tractroid-helicoidal shape, the signal output from the feeder horn 53 may naturally form a tractroid-helicoidal shape. Accordingly, the signal controller 11 may output the signal output from the feeder horn 53 without phase control in consideration of the configuration of the antenna structure 50 according to the second example embodiment.

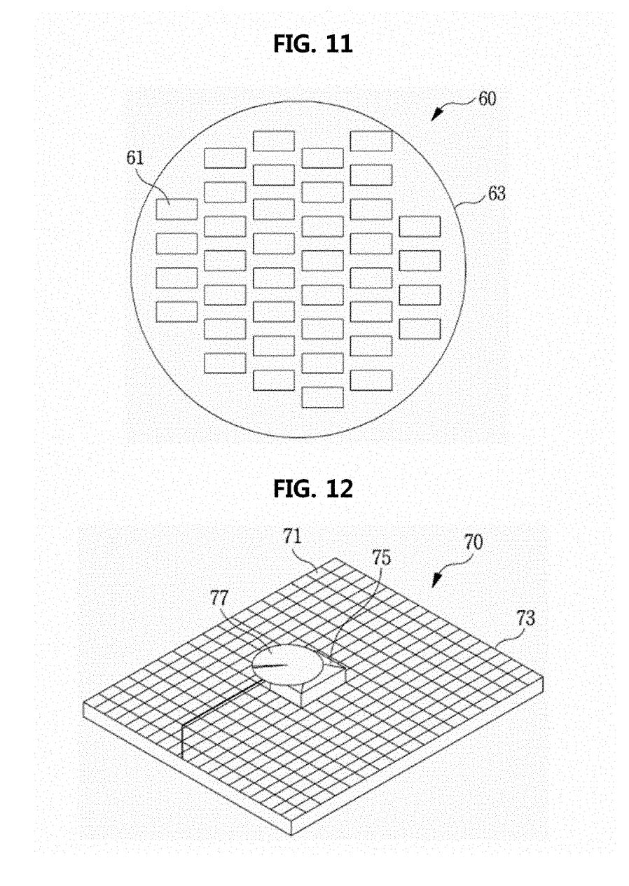

FIG. 11 is a third example diagram of an antenna structure provided in an OAM-mode antenna apparatus according to an example embodiment of the present invention.

Referring to FIG. 11, an antenna structure 60 according to a third example embodiment may include an antenna plate 63 on which a plurality of radiating elements 61 are two-dimensionally arranged.

The plurality of radiating elements 61 may be arranged on the antenna plate 63 in a circular shape, a rectangular shape, or various predetermined shapes. Further, the plurality of radiating elements 61 may have a metamaterial or an artificial electromagnetic structure.

Also, the plurality of radiating elements 61 may be connected to the signal controller 11, and the signal controller 11 may control a phase of a signal output from each of the plurality of radiating elements 61 according to the arrangement of the plurality of radiating elements 61 in consideration of the configuration of the antenna structure 60 according to the third example embodiment. Here, the signal controller 11 may variously set an OAM-based helical mode (−m, . . . , −2, −1, 0, +1, +2, . . . , and +m) to control phases of output signals.

The signal controller 11 may control the signals output from the plurality of radiating elements 61 on the basis of OAM modulation so that the output signals of the plurality of radiating elements 61 may form a tractroid-helicoidal phase surface.

FIG. 12 is a fourth example diagram of an antenna structure provided in an OAM-mode antenna apparatus according to an example embodiment of the present invention.

Referring to FIG. 12, an antenna structure 70 according to a fourth example embodiment of the present invention may have an antenna plate 73 on which a plurality of reflecting arrangement elements 71 are two-dimensionally arranged, a feeder horn 75, and an auxiliary reflecting plate 77 formed in a tractroid-helicoidal shape.

The feeder horn 75 may be fixed at a position opposite to the auxiliary reflecting plate 77, and the auxiliary reflecting plate 77 may be fixed at a position opposite to the antenna plate 73. Accordingly, a signal output from the feeder horn 75 is reflected by the auxiliary reflecting plate 77 first and provided to the antenna plate 73. Then, the signal which is reflected first by the auxiliary reflecting plate 77 and incident on the antenna plate 73, is reflected second by the plurality of reflecting arrangement elements 71 provided in the antenna plate 73 and output.

Here, since the auxiliary reflecting plate 77 is formed in a tractroid shape and a reflecting surface thereof has a helicoidal shape having a certain step, the signal reflected by the auxiliary reflecting plate 77 first may form a tractroid-helicoidal phase surface.

Accordingly, signals which are finally output from the plurality of reflecting arrangement elements 71 provided in the antenna plate 73, may also form a tractroid-helicoidal phase surface.

Further, the step of the reflecting surface formed in the auxiliary reflecting plate 77 may be set in consideration of a mode of the signal reflected by the auxiliary reflecting plate 77, for example, an OAM-based helical mode (−m, . . . , −2, −1, 0, +1, +2, . . . , and +m).

Meanwhile, the signal controller 11 may be connected to the feeder horn 75, and may output the signal output through the feeder horn 75 without phase control in consideration of the configuration of the antenna structure 70 according to the fourth example embodiment.

As another example, the auxiliary reflecting plate 77 may be formed in a tractroid shape. Also, the feeder horn 75 may have a feeder which outputs signals of different phases. For example, the feeder may be a 2×2 feeder. In this structure, a signal output from the 2×2 feeder may be controlled by the above-described signal controller 11. As an example, in consideration of the configuration of the auxiliary reflecting plate 77 in a tractroid shape, the signal may be controlled so that a signal provided to the antenna plate 73 through the auxiliary reflecting plate 77 forms a tractroid-helicoidal phase surface, like in the first example embodiment. For example, the signal controller 11 may control a phase of the signal output from the 2×2 feeder on the basis of OAM modulation.

Meanwhile, an antenna structure provided in an OAM-mode antenna apparatus according to an example embodiment of the present invention may include a circular leaky-wave antenna. In this case, the signal controller 11 may be connected to the leaky-wave antenna, and may control a signal output from the leaky-wave antenna. In other words, the signal controller 11 may control the signal output from the leaky-wave antenna on the basis of OAM modulation so that the output signal may form a tractroid-helicoidal phase surface. Here, the signal controller 11 may control a phase of the output signal by setting an OAM-based helical mode variously (−m, . . . , −2, −1, 0, +1, +2, . . . , and +m).

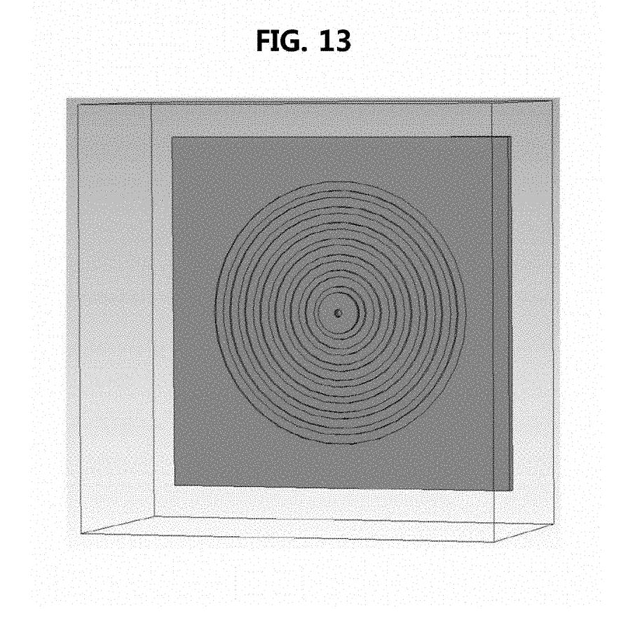

FIG. 13 is a fifth example diagram of an antenna structure provided in an OAM-mode antenna apparatus according to an example embodiment of the present invention.

An antenna shown in FIG. 13 may be a bull's eye antenna, and provided in the above-described OAM-mode antenna apparatus.

Using an apparatus of the present invention, it is possible to generate a higher-order Bessel beam pattern having OAM concentrated close to a propagation axis and, and it is possible to provide an electromagnetic wave generation apparatus that is relatively miniaturized by making an existing voluminous system into a plane and combining two functions of a OAM mode and a collimated mode.

While the example embodiments of the present invention and their advantages have been described in detail, it should be understood that various changes, substitutions and alterations may be made herein without departing from the scope of the invention.

What is claimed is:

1. An electromagnetic wave generation apparatus in a communication system, the electromagnetic wave generation apparatus comprising:
a circular array antenna generating a signal with orbital angular momentum (OAM),
wherein a shape of the electromagnetic wave generation apparatus is a cone, a plurality of antenna elements included in the circular array antenna are radially disposed on a side surface of the cone, and each of the plurality of antenna elements generate a signal with different phases.

2. The electromagnetic wave generation apparatus according to claim 1, wherein the circular array antenna generates a focused signal in the form of a high order Bessel beam.

3. The electromagnetic wave generation apparatus according to claim 1, wherein the plurality of antenna elements included in the circular array antenna are irregularly disposed in a radial direction.

4. The electromagnetic wave generation apparatus according to claim 1, wherein a phase difference between a first signal generated by a first antenna element from a vertex of the cone and a k-th signal generated by a k-th antenna element from the vertex of the cone is k·d sin θ.
